(19) United States
(12) Patent Application Publication
(10) Pub. No.: US 2007/0169269 A1
(43) Pub. Date: Jul. 26, 2007

(54) Ambulance cot with improved drop frame

(76) Inventor: Timothy R. Wells, Hillsboro, OH (US)

Correspondence Address: DINSMORE & SHOHL LLP;One Dayton Center, Suite 1300, One South Main Street, Dayton, OH, 45402-2023, US

(21) Appl. No.: 11/340,165

(22) Filed: Jan. 26, 2006

(51) Int. Cl. A61G 7/015

(52) U.S. Cl. 5/618; 5/620; 296/20

(57) ABSTRACT

A multiple level elevating cot adapted to be rolled into emergency vehicles, the cot having a wheeled undercarriage supporting a cot frame having a leading end and a trailing end, and adapted to selectively secure the cot frame in a plurality of elevational positions. The cot frame includes an improved drop frame having a wider range of motion to a cot construction. The cot frame is also provided with patient support features, such as positionable back, leg, and side arm supports.

### BACKGROUND OF THE INVENTION

This invention relates to ambulance cots and more particularly with improvements to multi-level roll-in cots capable of being used in different types of emergency vehicles having cot-receiving floors.

Ambulance cots typically comprise an essentially rectangular patient support frame with wheeled collapsible-leg assemblies enabling the stretcher to be stowed or loaded into the back of an ambulance. Examples of such prior art cots are disclosed in U.S. Pat. Nos. 4,097,941, 4,192,541, 4,767,148, 5,537,700, and 5,575,026. Although the prior art cots have been generally adequate for their intended purposes, they have not been satisfactory in all aspects. For example, in a confidence space with obstacles such as tables, chairs and/or desks, maneuvering a lowered cot can still possess some difficulties to an operator.

### SUMMARY OF THE INVENTION

The present invention alleviates or at least ameliorates the above-mentioned difficulties by providing a simple arrangement that conveniently provides an improved drop frame having a wider range of motion to a cot construction. The cot construction of the present invention includes a cot frame supported by a stable wheeled undercarriage, which permit the cot frame to be raised and lowered to a plurality of positions of use. The cot frame is also provided with patient support features, such as positionable back, leg, and side arm supports.

In one embodiment of the present invention, an elevating cot that is adapted to be rolled into emergency vehicles is disclosed. The cot comprises a generally rectangular cot frame, and a drop frame rotatably mounted to the cot frame. The drop frame is positionable in an extended position, and at least one position above the extended position.

In another embodiment of the present invention, an elevating cot that is adapted to be rolled into emergency vehicles is disclosed. The cot comprises a generally rectangular undercarriage having wheels, a generally rectangular cot frame having a leading end and a trailing end, and leg members interconnecting the cot frame and the undercarriage. The cot further includes a drop frame rotatably mounted to the cot frame. The drop frame is positionable in an extended position, and at least one position above the extended position.

These and other features and advantages of the invention will be more fully understood from the following description of some embodiments of the invention taken together with the accompanying drawings. It is noted that the scope of the claims is defined by the recitations therein, and not by the specific discussion of features and advantages set forth in the present description.

### BRIEF DESCRIPTION OF THE DRAWINGS

The present invention is illustrated by way of example and not limitation in the accompanying figures, in which like references indicate similar elements, and in which:

FIG. 1 is a side view of a cot structure embodiment of the invention in an elevated position;

FIG. 2 is a side view of the cot structure embodiment of FIG. 1, with a back support in a fully upright position and illustrating a drop frame with a wider range of motion then previously available in the prior art, the range of motion being indicated in dotted lines for purposes of illustration; and

FIG. 3 is an enlarged fragmented perspective view of a portion of the drop frame according to the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiment(s) of the present invention.

### DETAILED DESCRIPTION

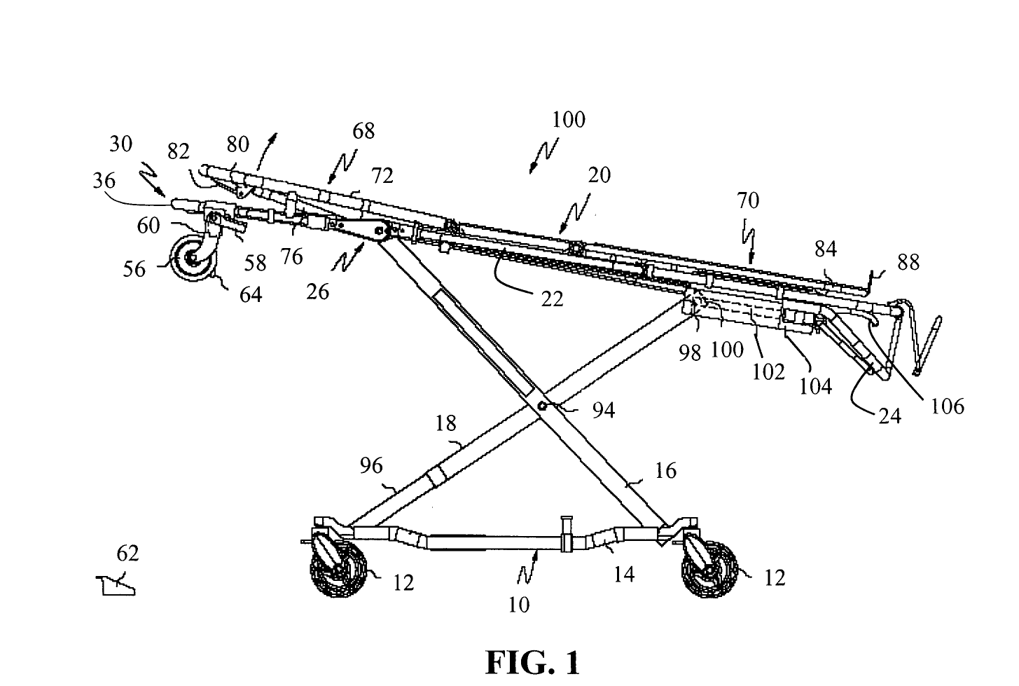

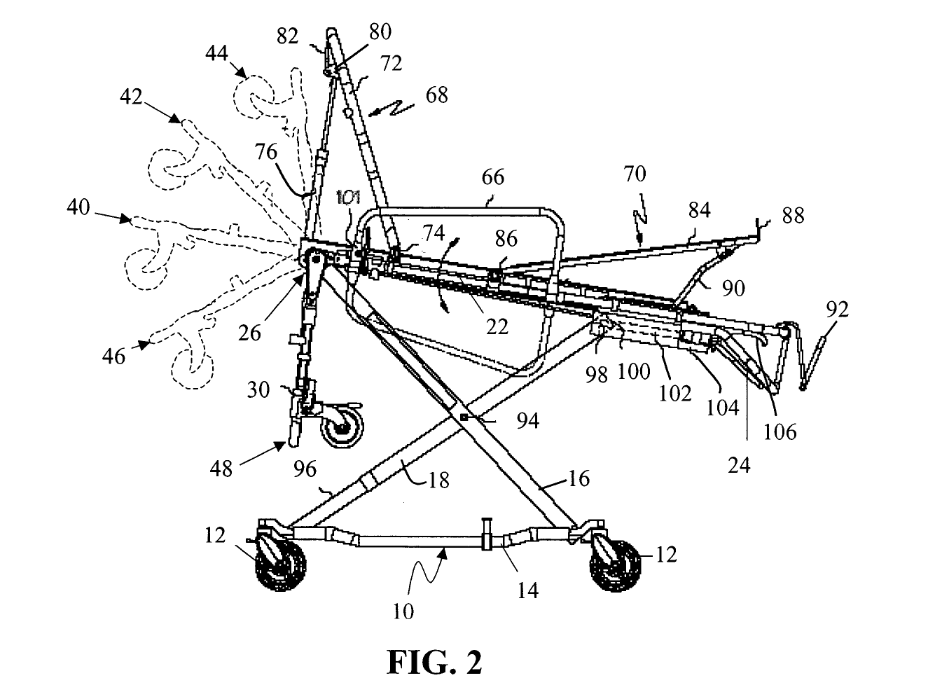

Referring first to FIGS. 1 and 2, illustrated is a cot structure embodiment of the invention indicated generally by symbol 100. The cot 100 has a rectangular undercarriage 10 mounting pairs of swivel caster wheels 12 at its opposite ends. It is to be appreciated that only one of the sides of the cot structure is illustrated for convenience, as the opposite side is substantially identical to the side shown. The undercarriage 10 includes opposing side frame members 14, which are interconnected by transverse frame members (not shown). Extending upwardly from the undercarriage 10 are pairs of cross forming frame members 16, 18, which serve to interconnect the undercarriage 10 with a cot frame 20.

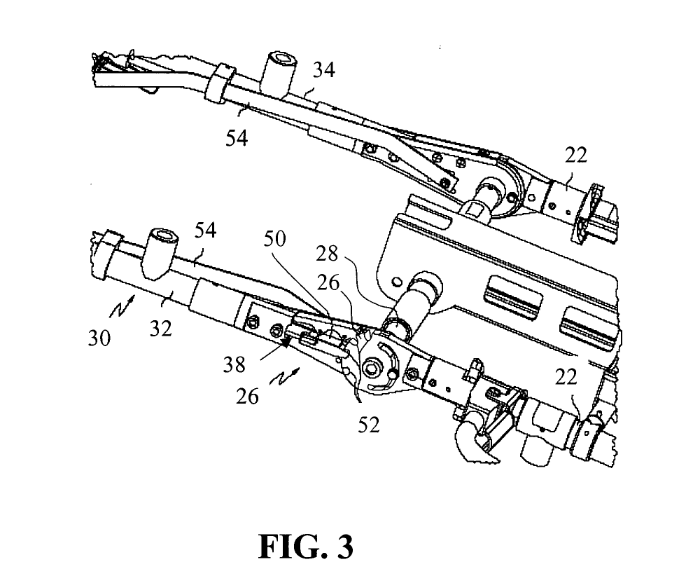

Cot frame 20 includes opposing tubular side frame members 22 interconnected at the foot or trailing end by a transverse tubular end member 24. At their leading or forward ends, the side frame members 22 each terminate at a respective hinge pivot 26. Supported between the pair of hinge pivots 26 is a transverse frame 28 having a drop frame 30 rotatably coupled thereto, which is best illustrated by FIG. 3.

Drop frame 30 includes tubular side frame portions 32 and 34 joined at their forward ends by an end frame member 36 (FIG. 1). In one embodiment, side frame portions 32 and 34, and end frame member 36 are a unitary piece. The drop frame 30 is releasable engaged by the pair of hinge pivots 26, which also limits the range of motion of drop frame 30. In particular, rotation of drop frame 30 is arrested by a latching mechanism, which is generally indicated by symbol 38. Latching mechanism 38 permits the drop frame 30 to be moved from the extended position 40, as seen in FIG. 1, to an upper middle position 42, to an upright position 44, a lower middle position 46 or to a collapsed position 48 also shown in FIG. 2. The dashed lines in FIG. 2 indicate the upper middle position 42, the upright position 44, and the lower middle position 46.

In one embodiment, the latching mechanism 38 includes a spring biased latch 50 which engages a respective one of slots 52 provided in each hinge pivot 26 to secure the drop frame 30 in either the extended position 40, the upper middle position 42, the upright position 44, or the lower middle position 46. The drop frame 30 hangs unsecured in the collapsed position 48. A release handle 54 of the latching mechanism 38 is provided to the drop frame 30 which releases the sliding latch 50 from one of the slots 52, such that the drop frame 30 may be repositioned if in the extended position 40, the upper middle position 42, the upright position 44, or the lower middle position 46.

It is to be appreciated that positioning the drop frame 30 in the lower middle position 46 provides a lower lifting handle position for improved ergonomics when the cot is fully elevated. Additionally, with the cot 100 in a lowered position, positioning the drop frame 30 in the upper middle position 42 also provides a higher lifting handle position for improved ergonomics. It is further to be appreciated that in a confidence space with obstacles such as tables, chairs and/or desks, placing the drop frame 30 in either the upper middle position 42, or the upright position 44, permits more convenient maneuvering of the cot when fully elevated by elevating the drop frame 30 out of the way of such obstacles.

The drop frame 30 is provided with a pair of loading wheels 56 projecting downwardly from the outermost ends of side frame sections. The loading wheels 56 are interconnected by a generally U-shaped tubular bail 58. The bail 58 is spring biased by springs 60 to the downwardly extending position seen in FIG. 1, and is configured to engage a tongue-like floor fitting 62 mounted on the floor of the emergency vehicle. The bail 58 is deflected upwardly by a release arm 64 positioned adjacent both sides of the cot frame 20, which permits the attendant to release the bail 58 from engagement with the floor fitting 26 when it is desired to remove the cot from the vehicle.

It will be understood that the basic cot frame 20 may be provided with various adjustable features, such as folding side arms 66, a multiple-position backrest 68, and an adjustable leg section 70 for placing the patient in a shock position, which is illustrated by FIG. 2. As best seen by FIG. 2, the backrest 68 has a generally u-shaped frame member 72 hinged at its ends to a traverse frame member spanning between side frame members 22, by means of pivot fittings 74. The backrest 68 is movable from a reclined position shown in FIG. 1, to an upright position illustrated in FIG. 2, and a plurality of positions therebetween by a lifting device 76. The lifting device 76 is pivotally attached at an upper end to a mount 80 of the backrest frame 68. In the illustrated embodiment of FIG. 1, manipulation of a lever 82 causes the lifting device 76 to raise or lower the backrest 68 as desired.

The adjustable leg section 70 is formed by u-shaped frame members 84 (partially shown in FIG. 2) hinged at its ends to a transverse tubular member of the cot frame 20 (not shown) by hinge members 86. At the opposed end of the frame member 84, a footrest 88 is mounted. The leg section 70 is raised and lowered by latch members 90 of known construction. Other features also may be provided, such as an auxiliary bail-like end frame member 92 underlying end frame member 12, which is positioned to be easily grasped by an attendant.

Referring to FIGS. 1 and 2, the pairs of cross-forming frame members 16, 18 are pivotally connected by a pivot rod 94 at the point of intersection of the pairs of cross-forming frame members 16, 18. In addition, the cross-forming frame members 18 telescopically receive tubular extensions 96 at their lowermost ends, which are pivotally connected to the undercarriage 10. At their uppermost ends the cross-forming frame members 18 mount fittings 98 having guide pins 100. The guide pins 100 are slidably received in a slot 102 of elongated guide members 104. A hand release 106 when operated permits sliding of the guide pins 100 within the slots, which permits rising and lowering of the cot frame 20 relative to the undercarriage 10 to any one of a number of elevational positions or collapsed against the undercarriage 10.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is therefore, claimed in any of its forms or modifications within the proper scope of the appended claims appropriately interpreted in accordance with the doctrine of equivalents. Any modification of the present invention that comes within the spirit and scope of the following claims should be considered part of the present invention.

What is claimed is:

1. An elevating cot adapted to be rolled into emergency vehicles, said cot comprising:
a generally rectangular cot frame; and
a drop frame rotatably mounted to said cot frame, said drop frame positionable in an extended position, and at least one position above the extended position.

2. The elevating cot as recited in claim 1, wherein said at least one position above the extended position is an upper middle position, and an upright position.

3. The elevating cot as recited in claim 1, wherein said drop frame is further positionable in a lower middle position providing improved lifting ergonomics.

4. The elevating cot as recited in claim 1, wherein said drop frame is further positionable in a lower middle position, and a collapsed position.

5. The elevating cot as recited in claim 1, wherein said drop frame is further positionable in a lower middle position, and wherein said at least one position above the extended position is an upper middle position, and an upright position.

6. The elevating cot as recited in claim 1, wherein said drop frame is further positionable in a lower middle position, and a collapsed position, and wherein said at least one position above the extended position is an upper middle position, and an upright position.

7. The elevating cot as recited in claim 1 wherein said drop frame include a pair of loading wheels.

8. The elevating cot as recited in claim 1, wherein said elevating cot further includes a latching mechanism for releasably securing said drop frame in one of said positions.

9. The elevating cot a recited in claim 1, wherein said drop frame is rotatably mounted to said cot frame by a pair of pivots mounts.

10. The elevating cot a recited in claim 1, wherein said drop frame is rotatably mounted to said cot frame by a pair of pivots mounts, each of said pivots mounts having a plurality of slots, said slots corresponding to said positions.

11. The elevating cot as recited in claim 1, wherein said drop frame is rotatably mounted to said cot frame by a pair of pivots mounts, each of said pivots mounts having a plurality of slots, said slots corresponding to said positions, and wherein said elevating cot further includes a latching mechanism for releasably securing said drop frame in one of said positions by being engaged in the corresponding one of said slots.

12. An elevating cot adapted to be rolled into emergency vehicles, said cot comprising:
a generally rectangular undercarriage having wheels;
a generally rectangular cot frame having a leading end and a trailing end;
leg members interconnecting said cot frame and said undercarriage; and
a drop frame rotatably mounted to said cot frame, said drop frame positionable in an extended position, and at least one position above the extended position.

13. The elevating cot as recited in claim 12, wherein said at least one position above the extended position is an upper middle position, and an upright position.

14. The elevating cot as recited in claim 12, wherein said drop frame is further positionable in a lower middle position, and wherein said at least one position above the extended position is an upper middle position, and an upright position.

15. The elevating cot as recited in claim 12, wherein said drop frame is further positionable in a lower middle position, and a collapsed position, and wherein said at least one position above the extended position is an upper middle position, and an upright position.

16. The elevating cot as recited in claim 12 wherein said drop frame include a pair of loading wheels.

17. The elevating cot as recited in claim 12, wherein said elevating cot further includes a latching mechanism for releasably securing said drop frame in one of said positions.

18. The elevating cot a recited in claim 12, wherein said drop frame is rotatably mounted to said cot frame by a pair of pivots mounts.

19. The elevating cot a recited in claim 12, wherein said drop frame is rotatably mounted to said cot frame by a pair of pivots mounts, each of said pivots mounts having a plurality of slots, said slots corresponding to said positions.

20. The elevating cot as recited in claim 12, wherein said drop frame is rotatably mounted to said cot frame by a pair of pivots mounts, each of said pivots mounts having a plurality of slots, said slots corresponding to said positions, and wherein said elevating cot further includes a latching mechanism for releasably securing said drop frame in one of said positions by being engaged in the corresponding one of said slots.
